(19) United States
(12) Patent Application Publication
(10) Pub. No.: US 2009/0065458 A1
(43) Pub. Date: Mar. 12, 2009

(54) RACK FOR HOLDING CENTRIFUGE TUBES

(76) Inventor: Douglas Murray, Novato, CA (US)

Correspondence Address: Vierra Magen Marcus & DeNiro LLP, 575 Market Street, Suite 2500, San Francisco, CA, 94105, US

(21) Appl. No.: 12/208,962

(22) Filed: Sep. 11, 2008

Related U.S. Application Data
(60) Provisional application No. 60/971,562, filed on Sep. 11, 2007.

(51) Int. Cl. B01L 9/06

(52) U.S. Cl. 211/85.18

(57) ABSTRACT

A rack for centrifuge tubes is disclosed including a plurality of receptacles sized to snugly receive one of a variety of different diameter centrifuge tubes. The rack may be formed of a variety of biodegradable, compostable materials, including for example molded polypropylene or organic resins such as a corn-based resin or potato-based resin. The rack further includes a lattice of recesses defined within an upper surface of the rack, which recesses extend between and connect the receptacles to add rigidity to the rack and flexibility to the individual receptacles.

### PRIORITY CLAIM

The present invention claims priority to provisional patent application No. 60/971,562, entitled “RACK FOR HOLDING CENTRIFUGE TUBES,” by Moulton et al., which application was filed on Sep. 11, 2007, and which application is incorporated by reference herein in its entirety.

### BACKGROUND OF THE INVENTION

1. Field of the Invention

The present invention relates to a pipette tip rack for storing pipette tips.

2. Description of the Related Art

Pipettes and pipette tips and tubes are widely used in chemistry, biomedical and bioengineering testing for dispensing and transporting discrete amounts of a test liquid in sterile conditions. A few decades ago, pipettes were individual dispensers made of glass, and were cleaned and sterilized after each use. However, widespread use has since occurred with the advent of plastic pipette tips and tubes for transporting and storing the test liquids.

Since great numbers of pipette tips and tubes are used, these tips and tubes are usually sold in racks. Racks may be rectangular trays having a matrix of receptacles for receiving the tips or tubes. The racks may either be loaded manually, or by automated loaders which are capable of loading an entire rack at the same time. Different racks have different sized receptacles for receiving different diameter pipette tips and tubes. For example, a standard 15 ml tube has a diameter of about 1.75 cm and a length of approximately 11.85 cm. Such 15 ml tubes are commonly stored in Styrofoam® racks, due to the good shock resistance and thermal insulating properties of the Styrofoam.

However, one drawback to Styrofoam racks is that Styrofoam takes a very long time to decompose and is rarely recyclable. For this reason, many cities in the U.S. have banned Styrofoam use in connection with food service. It is therefore desirable to provide a tube rack, which may advantageously be used for example with 15 mm tubes, and which is environmentally friendly.

### SUMMARY

Embodiments of the present invention relate to a rack for centrifuge tubes. The rack may include a plurality of receptacles sized to snugly receive one of a variety of different diameter centrifuge tubes, though it may alternatively store pipette tips of varying sizes in further embodiments. The rack may be formed of a variety of biodegradable, compostable materials, including for example molded polypropylene or organic resins such as a corn-based resin or potato-based resin. Other materials are contemplated. The rack further includes a lattice of recesses defined within an upper surface of the rack, which recesses extend between and connect the receptacles. The recesses add rigidity to the rack and a degree of flexibility to the individual receptacles.

The depth and spacing of the receptacles is provided to facilitate an optimal flow of heat into or away from the fluid stored within tubes. Thus, a greater length of the tube is exposed directly to the atmosphere surrounding the tubes. Moreover, the wall thickness of the rack is small, for example 0.02 inches thick, thus providing a negligible thermal barrier. Thus, even the portions of a tube seated within a receptacle are able to efficiently conduct heat into or away from the fluid in the tubes.

The rack includes side walls around the outer periphery of the rack which taper outward slightly from top to the bottom. This, together with the lattice of the receptacles, allows multiple racks to be stacked atop each other. The rack may further include interlock tabs which allow horizontally adjacent racks to be interlocked with each other.

### BRIEF DESCRIPTION OF THE DRAWINGS

FIG. 1 is a top view of a rack according to embodiments of the present invention.

FIG. 2 is a cross-sectional view through the rack of FIG. 1.

FIG. 3 is a top view of a rack according to embodiments of the present invention.

FIG. 4 is a cross-sectional view through the rack of FIG. 3.

FIG. 5 is a side view of the rack of FIG. 3.

FIG. 6 is an end view of the rack of FIG. 3.

FIGS. 7 and 8 are bottom and cross-sectional views of a pair of stacked racks according to embodiments of the present invention.

FIG. 9 is cross-section view of three stacked racks according to embodiments of the present invention.

FIG. 10 is a perspective view of a rack according to embodiments of the present invention.

FIG. 11 is an enlarged partial perspective view of the rack of FIG. 10.

FIG. 12 is a perspective view of a rack according to embodiments of the present invention holding centrifuge tubes.

FIG. 13 is a perspective view of a rack according to embodiments of the present invention illustrating an interlock tab for interlocking racks.

FIG. 14 is a top view of a rack according to embodiments of the present invention illustrating an interlock tab.

FIG. 15 is a cross-sectional view of the rack of FIG. 14.

FIG. 16 is an enlarged partial view of the interlock tab.

### DETAILED DESCRIPTION

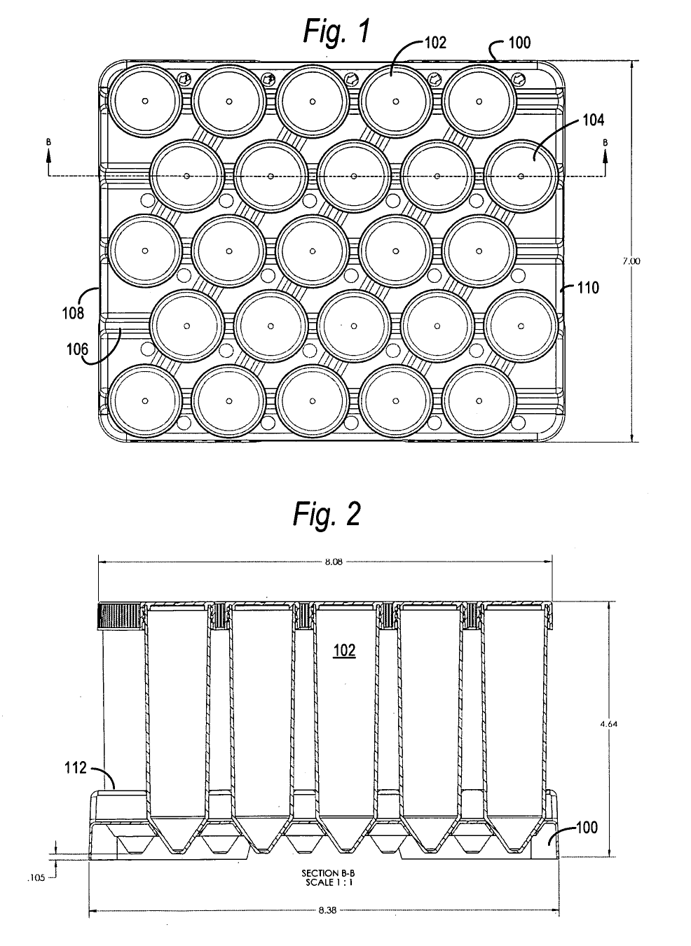

Embodiments of the present invention will now be described with reference to FIGS. 1 through 16, which in general relate to a rack for centrifuge tubes. It is understood that the present invention may be embodied in many different forms and should not be construed to being limited to the embodiments set forth herein. Rather, these embodiments are provided so that this disclosure will be thorough and complete and will fully convey embodiments of the invention to those skilled in the art. Indeed, the invention is intended to cover alternatives, modifications and equivalents of these embodiments, which are included within the scope and spirit of the invention as defined by the appended claims. Furthermore, in the following detailed description of embodiments of the present invention, numerous specific details are set forth in order to provide a thorough understanding of the present invention. However, it will be clear to those with ordinary skill in the art that the present invention may be practiced without such specific details.

Referring to FIGS. 1-6, there is shown a rack 100 for holding a plurality of centrifuge tubes 102. In embodiments, the rack 100 may include a plurality of receptacles 104 sized to snugly receive 15 ml centrifuge tubes. However, it is understood that the size and storage capacity of the tubes which may be stored in rack 100 may vary in alternative embodiments. Moreover, rack 100 may store pipette tips of varying sizes in further embodiments. In embodiments, rack 100 may have a length of about 5.75″, a width of 4.5″ and a depth of 1.5″. It is understood that each of these dimensions may vary above and below these dimensions in alternative embodiments. For example, alternative dimensions are shown on the drawing figures. Receptacles 104 may extend from a top surface 112 down substantially the entire depth of the rack 100.

In embodiments, the rack 100 may be formed of a variety of biodegradable, compostable materials, including for example molded polypropylene or organic resins such as a corn-based resin or potato-based resin. Rack 100 may be formed of a variety of other organically derived molecules in further embodiments. Rack 100 may further be formed of a variety of other hydrocarbon-based molecules. These materials have the advantage that they are easily recyclable, and thus provide advantages over the conventional Styrofoam racks. Rack 100 may be formed by a variety of known processes, such as for example injection molding. Moreover, the material from which rack 100 is formed maintains its structure and does not fall apart, which is a further advantage over Styrofoam, which tends to break apart over time. A further advantage to the use of the above materials is that rack 100 and the tubes 102 therein may be immersed in a liquid bath. The buoyancy of Styrofoam prevents this in conventional racks.

The rack 100 further includes a lattice of recesses 106 defined within the rack, which recesses 106 extend between and connect the receptacles 104. The recesses 106 may be oriented horizontally (i.e., extending between a first end 108 and a second end 110) and/or diagonally (i.e., at an oblique angle with respect to the horizontal recesses). The recesses 106 add rigidity to the rack 106.

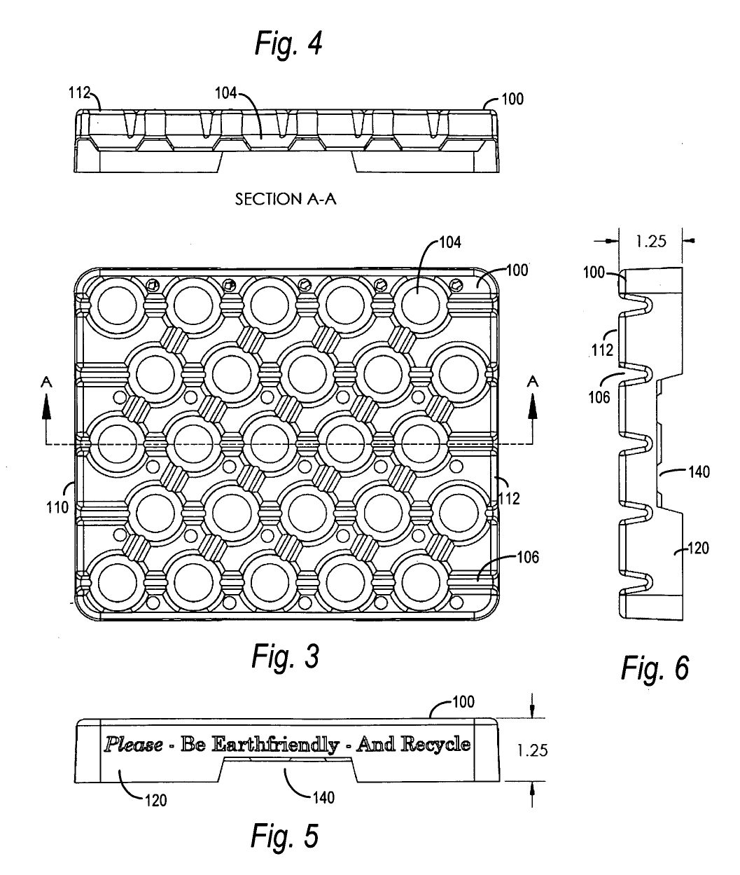

As seen for example in FIGS. 3, 6 and 11, in embodiments, the recesses 106 may be open at a top surface 112 of rack 106, connecting each of the receptacles 104. The recesses 106 may taper to a narrower diameter, terminating at or near the base of each receptacle 104. Thus, in embodiments, the receptacles 104 are not enclosed cylinders, but rather are intersected by the recesses 106. At least the majority of receptacles may be intersected by recesses 106 at four sections around the periphery of the receptacles, though it may be more or less than that in alternative embodiments. Thus, while the recesses add structural rigidity to the rack 100 as a whole, the recesses 106 add a degree of flexibility to the individual receptacles 104.

The depth and spacing of the receptacles is provided to facilitate an optimal flow of heat into or away from the fluid stored within tubes 102. For example, the depth of the rack is smaller than conventional Styrofoam racks. Thus, a greater length of the tube is exposed directly to the atmosphere surrounding the tubes. Moreover, the wall thickness of the rack is small, for example 0.02 inches thick, thus providing a negligible thermal barrier. This thickness may vary in alternative embodiments. Thus, even the portions of a tube seated within a receptacle are able to efficiently conduct heat into or away from the fluid in the tubes. As an example, if the rack 100 with tubes 102 is placed within a cooling unit, the temperature of the fluid within the tubes may decrease rapidly and uniformly along the length of the tubes. This is an advantage over Styrofoam, which is a natural insulator.

Moreover, the receptacles allow a spacing between tubes 102 which also facilitates heat flow into or away from fluid within the tubes. This is an advantage over Styrofoam racks, where tubs were packed very closely together. In embodiments, the receptacles may allow a spacing of between 0.1″ to 0.25″ between tubes, though it may be smaller or greater than that in alternative embodiments. This spacing also makes it easy to grip and remove tubes from the rack 100. It is understood that tubes 100 may be spaced together with the same spacing as in conventional Styrofoam racks. In such embodiments, the advantages described herein with respect to spacing of the receptacles may be negated.

As shown for example in FIG. 5, the use of the material of the present invention also allows imprinting on the rack 100. Thus, a lot number, slogan, brand or other text or symbols may be provided on rack 100. This is a further advantage over Styrofoam, which typically is not able to carry printing.

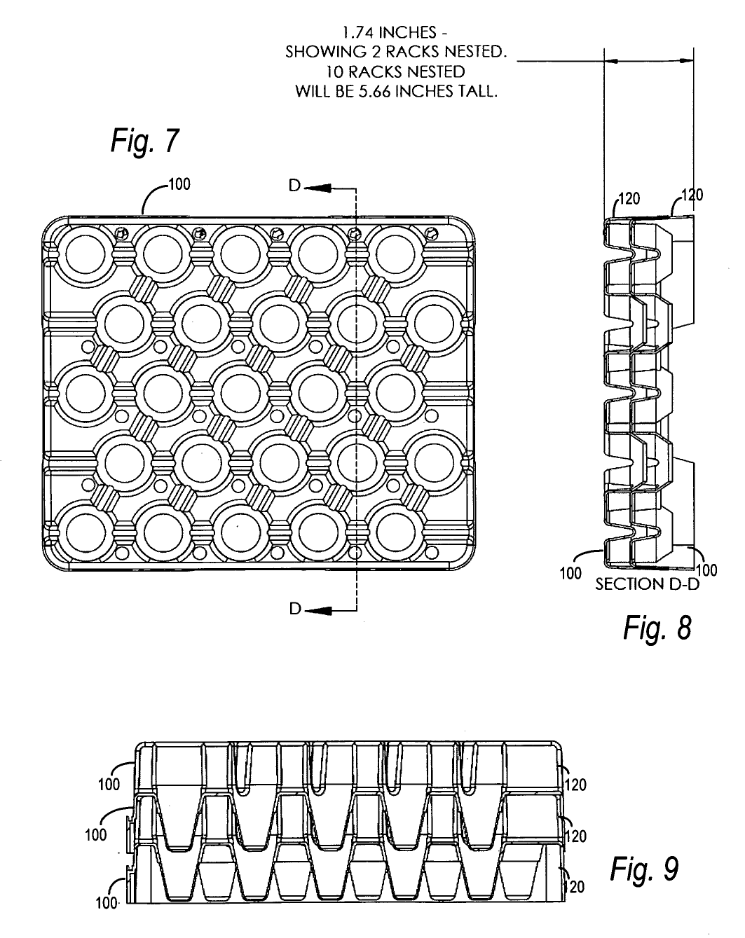

Referring now to FIGS. 1-6 as above and further FIGS. 7-10, the rack 100 includes side walls 120 which taper outward slightly from top surface 112. This, together with the lattice of the receptacles, allows multiple racks to be stacked atop each other. In embodiments, ten racks may be stacked to a height of between approximately 5″ and 6″. It is also conceivable to form the bottom surface of the rack 100 so that two or more racks loaded with tubes 102 may be stacked atop each other.

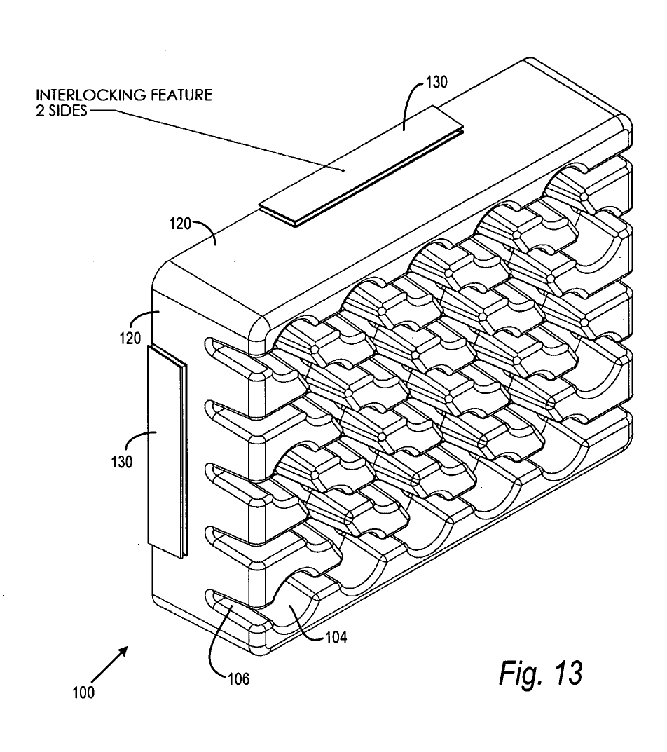

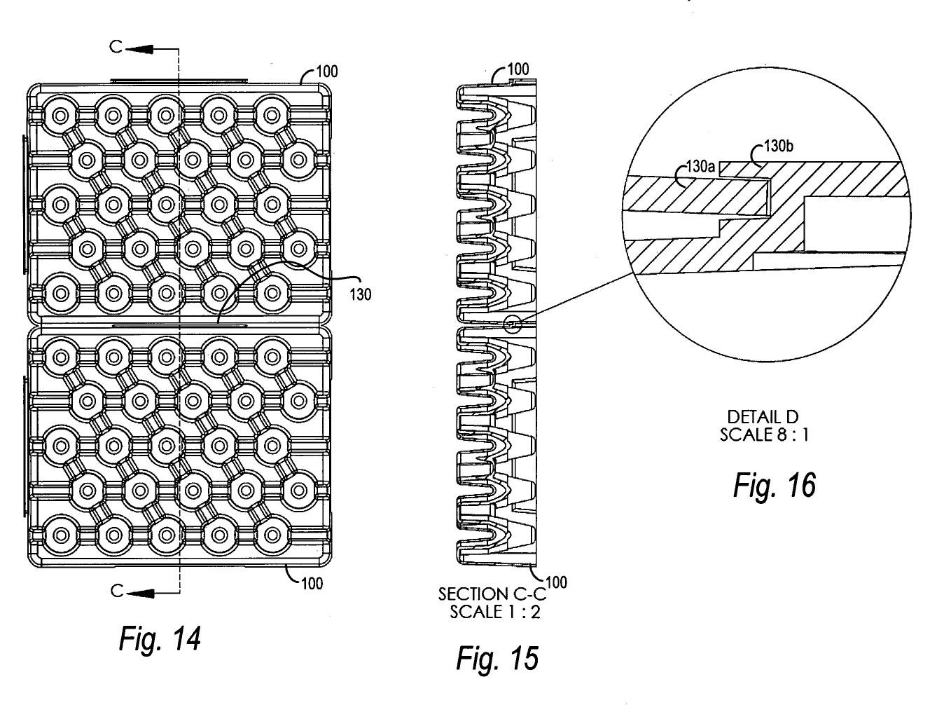

Referring now to FIGS. 13-16, rack 100 may further include interlock tabs 130 formed during the injection molding process or other process. As best seen in FIGS. 14-16, the tabs 130 allow adjacent racks to be interlocked with each other. Referring specifically to FIG. 16, the tabs may be formed so that a male tab 130a on a side 120 of a first rack mates with a female tab 130b on a side 120 of a second rack. Each rack may include one, two, three or four tabs on respective sides 120 of the rack. In embodiments, a first side may include a male tab, and the opposed side may include a female tab. Alternatively, there may be two sets of racks, with a first set including only male tabs and a second set including only female tabs.

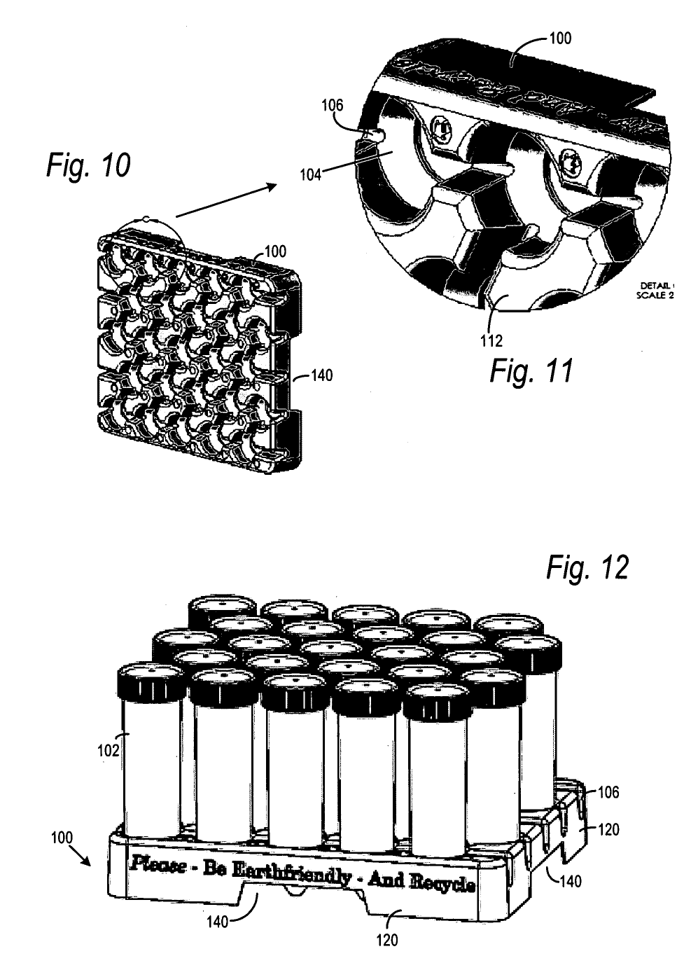

As seen for example in FIGS. 10-12, the tabs 130 may be omitted in embodiments. Embodiments in which tabs 130 are included or omitted may further include cut-out notches 140 formed in sidewalls 120. Notches 140 allow easy gripping and transport of racks 100. Moreover, a robotic finger or tray may fit beneath the rack 100 within notches 140 formed on opposed sides of the rack 100 to allow robotic and automated handling and transfer of racks 100. Such robotic and automated handling is not possible with conventional Styrofoam racks. Moreover, the spacing between individual tubes also facilitates automated handling and transfer of individual tubes 102 within a rack 100.

The foregoing detailed description of the invention has been presented for purposes of illustration and description. It is not intended to be exhaustive or to limit the invention to the precise form disclosed. Many modifications and variations are possible in light of the above teaching. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. A rack for holding tubes, comprising:
a plurality of receptacles;
a plurality of recesses extending between and connecting the plurality of receptacles;
wherein the rack is formed of one or more biodegradable materials.

2. A rack as recited in claim 1, further including interlocking tabs allowing the rack to affixed side-by-side with another rack.

3. A rack as recited in claim 1, wherein the receptacles are provided in a matrix allowing the rack to stacked above and/or beneath another rack.

4. A rack as recited in claim 1, wherein the receptacles are provided to snugly receive 15 ml centrifuge tubes.

5. A rack as recited in claim 1, wherein the rack is formed of a compostable material.

6. A rack as recited in claim 1, wherein the rack is formed of one of molded polypropylene and an organic resin.

7. A rack as recited in claim 6, wherein rack is formed of one of a corn-based and potato based resin.

8. A rack as recited in claim 1, wherein plurality of receptacles are spaced between 0.1 inches and 0.25 inches from each other.

9. A rack as recited in claim 1, wherein the plurality of recesses add structural rigidity to the rack and flexibility to the receptacles.

10. A rack as recited in claim 1, wherein plurality of recesses are formed parallel to an outer edge of the rack.

11. A rack as recited in claim 1, wherein plurality of recesses are formed at an oblique angle to an outer edge of the rack.

12. A rack as recited in claim 1, wherein plurality of recesses intersect a receptacle of the plurality of receptacles at four locations around a circumference of the receptacle.

13. A rack as recited in claim 1, wherein the rack includes a generally rectangular upper surface and four downwardly extending sidewalls from the upper surface, the downwardly extending sidewalls tapering outward top to bottom to enable stacking of the rack on top of a second, similarly configured rack.

14. A rack as recited in claim 13, further including notches formed in two or more of the downwardly extending sidewalls, the notches allowing at least one of manual and automated gripping and transfer of the rack.

15. A rack for holding tubes, the rack including an upper surface and downwardly extending sidewalls off of the upper surface, the rack comprising:
a plurality of receptacles;
a plurality of recesses extending between and connecting the plurality of receptacles, the plurality of recesses intersect a receptacle of the plurality of receptacles at four locations around a circumference of the receptacle, the plurality of recesses adding structural rigidity to the rack and flexibility to the receptacle;
wherein the rack is formed of one or more biodegradable materials.

16. A rack as recited in claim 15, wherein the receptacles are provided to snugly receive 15 ml centrifuge tubes.

17. A rack as recited in claim 15, wherein the rack is formed of a compostable material.

18. A rack as recited in claim 15, wherein the rack is formed of one of molded polypropylene and an organic resin.

19. A rack as recited in claim 18, wherein rack is formed of one of a corn-based and potato based resin.

20. A rack as recited in claim 15, wherein the downwardly extending sidewalls taper outward top to bottom to enable stacking of the rack on top of a second, similarly configured rack.

21. A rack as recited in claim 20, further including notches formed in two or more of the downwardly extending sidewalls, the notches allowing at least one of manual and automated gripping and transfer of the rack.

22. A rack for holding tubes, the rack including an upper surface and downwardly extending sidewalls off of the upper surface, the rack comprising:
a plurality of receptacles sized to snugly hold 15 ml centrifuge tubes;
a plurality of recesses extending between and connecting the plurality of receptacles, the plurality of recesses intersect a receptacle of the plurality of receptacles at four locations around a circumference of the receptacle, the plurality of recesses adding structural rigidity to the rack and flexibility to the receptacle;
interlocking tabs allowing the rack to affixed side-by-side with another rack;
notches formed in two or more of the downwardly extending sidewalls, the notches allowing at least one of manual and automated gripping and transfer of the rack;
wherein the rack is formed of one or more of a biodegradable materials, compostable material.

23. A rack as recited in claim 22, wherein the rack is formed of one of molded polypropylene and an organic resin.

24. A rack as recited in claim 23, wherein rack is formed of one of a corn-based and potato based resin.

25. A rack as recited in claim 22, wherein the downwardly extending sidewalls taper outward top to bottom to enable stacking of the rack on top of a second, similarly configured rack.
